(19) United States
(12) Patent Application Publication
(10) Pub. No.: US 2025/0253605 A1
(43) Pub. Date: Aug. 7, 2025

(54) SYSTEM AND METHOD FOR GENERATING VISIBLE-TO-MID-INFRARED FREQUENCY COMB

(71) Applicant: BEIJING AEROSPACE INSTITUTE FOR METROLOGY AND MEASUREMENT TECHNOLOGY, Beijing (CN)

(72) Inventors: Beibei WANG, Beijing (CN); Xiaoqiang GAO, Beijing (CN); Tieli ZHANG, Beijing (CN); Yinxiao MIAO, Beijing (CN); Zhitao ZHANG, Beijing (CN); Weiwei WU, Beijing (CN); Yongyao XU, Beijing (CN); Hao LIU, Beijing (CN)

(21) Appl. No.: 19/189,107

(22) Filed: Apr. 24, 2025

(30) Foreign Application Priority Data
Aug. 15, 2024 (CN) 202411122657.5

(51) Int. Cl. H01S 3/067; G02F 1/35; G02F 1/355; H01S 3/00; H01S 3/0941; H01S 3/1118

(52) U.S. Cl. CPC H01S 3/06712; G02F 1/3528; G02F 1/3558; H01S 3/0057; H01S 3/06716; H01S 3/0941; H01S 3/1118

(57) ABSTRACT

A system for generating a visible-to-mid-infrared frequency comb, including an all polarization-maintaining fiber-based frequency comb module and an optical frequency comb spectral expansion module. The all polarization-maintaining fiber-based frequency comb module is configured to generate a laser with evenly spaced and coherent frequencies and spectral lines. The optical frequency comb spectral expansion module is configured to perform spectral expansion on the laser to output the visible-to-mid-infrared frequency comb. The optical frequency comb spectral expansion module includes an amplifier, a 90:10 beam splitter, a first all polarization-maintaining compression fiber, a second all polarization-maintaining compression fiber, a 1100 nm-2350 nm supercontinuum unit and a 500 nm-1100 nm supercontinuum unit. A circuit of a semiconductor laser diode unit is configured to control output of the 1100 nm-2350 nm laser.

### CROSS-REFERENCE TO RELATED APPLICATIONS

This application claims the benefit of priority from Chinese Patent Application No. 202411122657.5, filed on Aug. 15, 2024. The content of the aforementioned application, including any intervening amendments made thereto, is incorporated herein by reference in its entirety.

### TECHNICAL FIELD

This application relates to laser measurement, and more particularly to a system and a method for generating a visible-to-mid-infrared frequency comb, which are used for calibrating lasers of different wavelengths and measuring various gas samples.

### BACKGROUND

Optical frequency comb (OFC) has the capability to define optical frequency entirely based on microwave frequency. It can precisely transfer phase and frequency information from a highly stable reference to the optical domain at the order of hundreds to thousands of frequency beats. Additionally, the OFC provides an almost continuous spectral coverage from microwave frequency to the extreme ultraviolet region, making it indispensable in fundamental scientific research, frequency metrology, laser ranging and optical communication.

The discrete comb-like structure of the optical frequency comb in the frequency domain makes it directly applicable to precision optical frequency measurements. When the frequency is referenced to a stable source, each comb tooth attains exceptional frequency stability and accuracy. Therefore, in the frequency domain, the optical frequency comb can be considered as an optical frequency ruler with extremely high precision (Kim S W. Metrology: Combs rule [J]. Nature Photonics, 2009, 3(6):313-314).

In general, when a molecule interacts with a light source, absorption occurs at specific bands, and each molecule exhibits multiple absorption bands, which are determined by its energy level structure. Different types of molecules correspond to distinct absorption bands, effectively serving as unique spectral signatures for molecular identification. Due to the rich spectral components of the OFC, its output spectrum typically contains millions of comb teeth. When the frequency of the OFC is referenced to an atomic clock or an optical standard, each comb tooth functions as a frequency-stable, narrow-linewidth continuous-wave laser. Therefore, when the OFC is used as a light source to interact with a molecule, a characteristic absorption spectrum is generated. By analyzing the obtained spectrum, the molecular composition and concentration of the sample can be accurately determined.

Currently, a near-infrared band optical frequency comb combined with a nonlinear frequency conversion technology can shift the comb teeth frequencies from a near-infrared band to a mid-infrared band (SCHLIESSER A, PICQUE N, HANSCH T W. Mid-infrared frequency combs [J]. Nature Photonics, 2012, 6(7):440-449). This technology is widely used in optical parametric oscillators for generating the mid-infrared band optical frequency combs (JIN Y W, CRISTESCU S M, HARREN F J M, et al. Two-crystal mid-infrared optical parametric oscillator for absorption and dispersion dual-comb spectroscopy [J]. Optics Letters, 2014, 39(11):3270-3273).

In 2018, Ycas G et al. from the National Institute of Standards and Technology (NIST) in the United States used a mode-locked femtosecond fiber frequency comb operating in the near-infrared band to pump a periodically poled lithium niobate (PPLN) crystal, generating a mid-infrared band idler optical frequency comb (as shown in FIG. 1). The spectral coverage of the idler optical frequency comb is 3000 nm-5000 nm (YCAS G, GIORGETTA F R, BAUMANN E, et al. High-coherence mid-infrared dual-comb spectroscopy spanning 2.6 to 5.2 μm [J]. Nature Photonics, 2018, 12(4): 202-208).

Currently, the nonlinear frequency conversion technology has enabled the conversion of the operating wavelength of a near-infrared pump optical frequency comb source to the mid-infrared band, as reported in various studies. Although these approaches facilitate the operating wavelength shifting to specific spectral windows, they fail to expand the overall bandwidth of the optical frequency comb. The resulting spectral broadening occurs only at spectral regions far from the pump frequency and is accompanied by noise accumulation, resulting in significant degradation of the comb tooth structure. To date, no disclosures in the industry have reported an optical frequency comb with a wavelength coverage extending from the visible light to the mid-infrared band (e. g., 500 nm-2350 nm).

The optical frequency comb spanning from visible light to mid-infrared band (500 nm-2350 nm) is required because this range encompasses the spectral ranges of several typical commercial lasers, such as those operating at 543 nm, 633 nm, 1030 nm, 1064 nm, 1550 nm and 2000 nm. Developing an optical frequency comb device that covers the 500 nm-2350 nm wavelength range can enable wavelength measurement and calibration for these typical commercial lasers. Additionally, within the 500 nm-2350 nm wavelength range, there are absorption peaks of various gases and toxic substances, such as water vapor (H₂O), hydrogen peroxide (H₂O₂), ammonia (NH₃), carbon dioxide (CO₂), carbon monoxide (CO), hydrogen sulfide (H₂S), hydrogen chloride (HCl), hydrogen fluoride (HF), methane (CH₄), ethane (C₂H₆) and acetylene (C₂H₂). Many molecules exhibit characteristic absorption lines within this wavelength range, making the development of the optical frequency comb device spanning from visible light to the mid-infrared band (500 nm-2350 nm) highly valuable for spectral analysis and molecular detection applications.

Additionally, the optical frequency comb is typically stabilized by locking it to an external reference light source (i.e., the frequency of the external reference light source) to enhance its precision and stability. In such cases, a rubidium atomic clock is often employed as the external reference light source to provide a highly stable and accurate frequency. This ensures that the frequency of the optical frequency comb remains synchronized with the reference light source, thereby improving its accuracy and stability. However, the stability of a repetition frequency of the optical frequency comb locked to the rubidium atomic clock is generally on the order of 10-11 or approaching 10-12. Therefore, there is an urgent need to enhance the stability of the repetition frequency to a higher order of magnitude to improve measurement accuracy.

### SUMMARY

In view of this, an object of the present disclosure is to provide a system and a method for generating a visible-to-mid-infrared frequency comb. Through this system, the comb tooth frequencies of the frequency comb can be expanded to the range from visible to the mid-infrared band, which provides significant application value in spectral analysis and molecular detection.

Technical solutions of the present disclosure are described as follows.

A system for generating a visible-to-mid-infrared frequency comb, comprising:
an all polarization-maintaining fiber-based frequency comb module; and
an optical frequency comb spectral expansion module;
wherein the all polarization-maintaining fiber-based frequency comb module is configured to generate a laser with evenly spaced and coherence frequencies and spectral lines;
the optical frequency comb spectral expansion module is configured to perform spectral expansion on the laser to output the visible-to-mid-infrared frequency comb;
the optical frequency comb spectral expansion module comprises a first amplifier, a 90:10 beam splitter, a first all polarization-maintaining compression fiber, a second all polarization-maintaining compression fiber, a 1100 nm-2350 nm supercontinuum unit and a 500 nm-1100 nm supercontinuum unit; the 90:10 beam splitter has a split ratio of 90:10;
the first amplifier is configured to perform pulse amplification on the laser generated from the all polarization-maintaining fiber-based frequency comb module to obtain an amplified laser; the 90:10 beam splitter is configured to split the amplified laser into a first laser beam and a second laser beam;
the first laser beam is configured to be output from a 10% splitting port of the 90:10 beam splitter to pass through the second all polarization-maintaining compression fiber to enter the 1100 nm-2350 nm supercontinuum unit;
the second laser beam is configured to be output from a 90% splitting port of the 90:10 beam splitter to pass through the first all polarization-maintaining compression fiber to enter the 500 nm-1100 nm supercontinuum unit;
the 1100 nm-2350 nm supercontinuum unit comprises a second amplifier, a passive optical fiber and a first highly nonlinear fiber; and the first laser beam is configured to pass through the second amplifier, the passive optical fiber and the first highly nonlinear fiber; and
the second amplifier is connected to a first semiconductor laser diode unit through an optical fiber; and a circuit of the first semiconductor laser diode unit is configured to be connected to output a 1100 nm-2350 nm (near-infrared to mid-infrared) laser.

In some embodiments, the all polarization-maintaining fiber-based frequency comb module comprises a laser, a third amplifier, a third all polarization-maintaining compression fiber, a second highly nonlinear fiber, a collinear self-referencing f-to-2f beat-frequency detection device and a frequency locking unit;
the laser is configured to output a laser to pass sequentially through the third amplifier, the third all polarization-maintaining compression fiber, the second highly nonlinear fiber, the collinear self-referencing f-to-2f beat-frequency detection device and the frequency locking unit;
the laser comprises a piezoelectric ceramic actuator, and the piezoelectric ceramic actuator is configured to stretch an optical fiber in the laser to lock a repetition frequency onto an atomic clock of the frequency locking unit;
the collinear self-referencing f-to-2f beat-frequency detection device is configured to lock a detected radio-frequency signal to the atomic clock of the frequency locking unit;
wherein the detected radio-frequency signal is a carrier-envelope offset (f_{ceo}) signal; and
the atomic clock is a hydrogen atomic clock.

In some embodiments, the laser further comprises a semiconductor saturable absorber mirror (SESAM) component, a polarization-maintaining erbium-doped fiber, a semiconductor laser diode and an output mirror;
the optical fiber stretched by the piezoelectric ceramic actuator is the polarization-maintaining erbium-doped fiber;
the SESAM component is provided on a first side of a linear cavity of the laser;
the semiconductor laser diode is a pump source;
the output mirror is provided on a second side of the linear cavity of the laser, and is configured to reflect a laser emitted from the semiconductor laser diode to the polarization-maintaining erbium-doped fiber to provide excitation;
a first end of the polarization-maintaining erbium-doped fiber is connected to the SESAM component, and a second end of the polarization-maintaining erbium-doped fiber is connected to the output mirror;
a reflection-to-transmission ratio of the output mirror is 90:10;
the output mirror is configured to output 10% of a signal light in the linear cavity as an output of the laser; and
the laser is a femtosecond laser.

In some embodiments, the 500 nm-1100 nm supercontinuum unit comprises a first collimation assembly and a first half-wave plate, a periodically poled lithium niobate (PPLN) crystal, a second collimation assembly, a second half-wave plate and a photonic crystal fiber;
the first collimation assembly, the first half-wave plate, the PPLN crystal, the second collimation system, the second half-wave plate and the photonic crystal fiber are sequentially arranged along an optical path; and the PPLN crystal is configured to perform frequency multiplication on the laser;
the first collimation assembly and the first half-wave plate are configured to adjust a pulse pump laser power incident on the PPLN crystal to control a shape and a power density distribution of a supercontinuum spectrum; and
the second collimation assembly and the second half-wave plate are configured to adjust a pulse pump laser power incident on the photonic crystal fiber to control the shape and the power density distribution of the supercontinuum spectrum.

In some embodiments, the laser further comprises a standard
polarization-maintaining single-mode fiber; the polarization-maintaining erbium-doped fiber and the standard polarization-maintaining single-mode fiber are accommodated in the linear cavity; and the polarization-maintaining erbium-doped fiber and the standard polarization-maintaining single-mode fiber are both negative dispersion fibers;
the first amplifier comprises a second semiconductor laser diode unit;
the second semiconductor laser diode unit is configured to supply a pumping power to the first amplifier; and
the first amplifier is configured to output an average power of 600 mW in response to a case that the pumping power of the second semiconductor laser diode unit is increased to 2000 mW.

Compared to the prior art, the present disclosure has the following beneficial effects.
1. The system for generating a visible-to-mid-infrared frequency comb is provided, where circuits of two first semiconductor laser diode units in the second amplifier can control output of the 1100 nm-2350 nm laser, covering the near-infrared to mid-infrared band. In this way, the system can more specifically conduct high-efficiency measurement of the laser under test.
2. The system provided herein adopts the all polarization-maintaining fiber-based frequency comb module and the optical frequency comb spectral expansion module. This configuration enables the supercontinuum output of a 500 nm-2350 nm frequency comb, covering the band from visible to mid-infrared, thereby providing detection capabilities for lasers across a broader wavelength range. Furthermore, the system enables the simultaneous detection of multiple gases.
3. The system provided herein employs the hydrogen atomic clock as an frequency comb locking reference module. This configuration enables a repetition frequency stability on the order of 10-13, improving the locking accuracy by an order of magnitude compared to current rubidium atomic clocks, thereby enhancing the measurement precision of a wavelength of a to-be-tested laser.

### BRIEF DESCRIPTION OF THE DRAWINGS

FIG. 1 schematically shows a principle of a device for generating a mid-infrared idler frequency comb based on a periodically poled lithium niobate (PPLN) crystal in the prior art; and

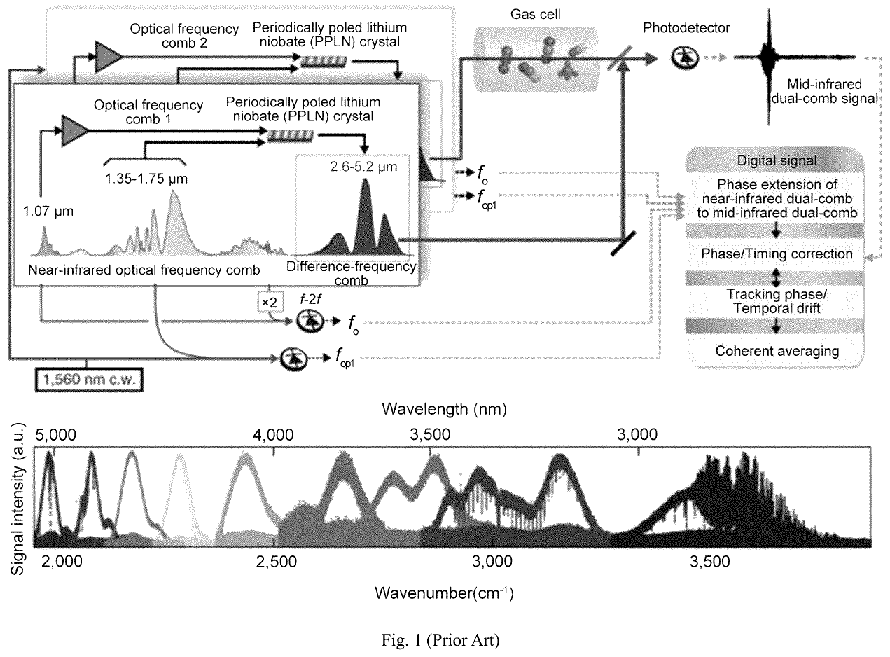

FIG. 2 is a structural diagram of a system for generating a visible-to-mid-infrared frequency comb according to an embodiment of the present disclosure.

In the figures: 1—all polarization-maintaining fiber-based frequency comb module; 2—optical frequency comb spectral expansion module; 3—laser; 31—polarization-maintaining erbium-doped fiber; 32—first semiconductor laser diode; 33—output mirror; 34—semiconductor saturable absorber mirror (SESAM) component; 35—piezoelectric ceramic actuator; 5—first amplifier; 51—second semiconductor laser diode; 52—third semiconductor laser diode; 53—fourth semiconductor laser diode; 6—first all polarization-maintaining compression fiber; 7—first highly nonlinear fiber; 8—collinear self-referencing f-to-2f beat-frequency detection device; 81—first lens; 82—second lens; 83—third lens; 84—fourth lens; 85—first periodically poled lithium niobate (PPLN) crystal; 9—frequency locking unit; 10—atomic clock; 11—second amplifier; 11-1—first semiconductor laser diode unit; 11-1-1—fifth semiconductor laser diode; 11-1-2—sixth semiconductor laser diode; 11-1-3—seventh semiconductor laser diode; 12—90:10 beam splitter; 13—second all polarization-maintaining compression fiber; 14—third all polarization-maintaining compression fiber; 15—1100 nm-2350 nm supercontinuum unit; 15-2—third amplifier; 15-2-1—eighth semiconductor laser diode; 15-2-2—ninth semiconductor laser diode; 15-3—second highly nonlinear fiber; 15-4—second semiconductor laser diode unit; 16—500 nm-1100 nm supercontinuum unit; 16-1—second PPLN crystal; 16-2—photonic crystal fiber; 16-3—first collimation assembly and first half-wave plate; and 16-4—second collimation assembly and second half-wave plate.

### DETAILED DESCRIPTION OF EMBODIMENTS

Technical solutions in the embodiments of the present disclosure will be described clearly and completely below in conjunction with the accompanying drawings. It is obvious that described below are merely some embodiments of the present disclosure, instead of all embodiments. Based on the embodiments in the present disclosure, all other embodiments obtained by those of ordinary skill in the art without making creative effort shall fall within the scope of the present disclosure defined by the appended claims.

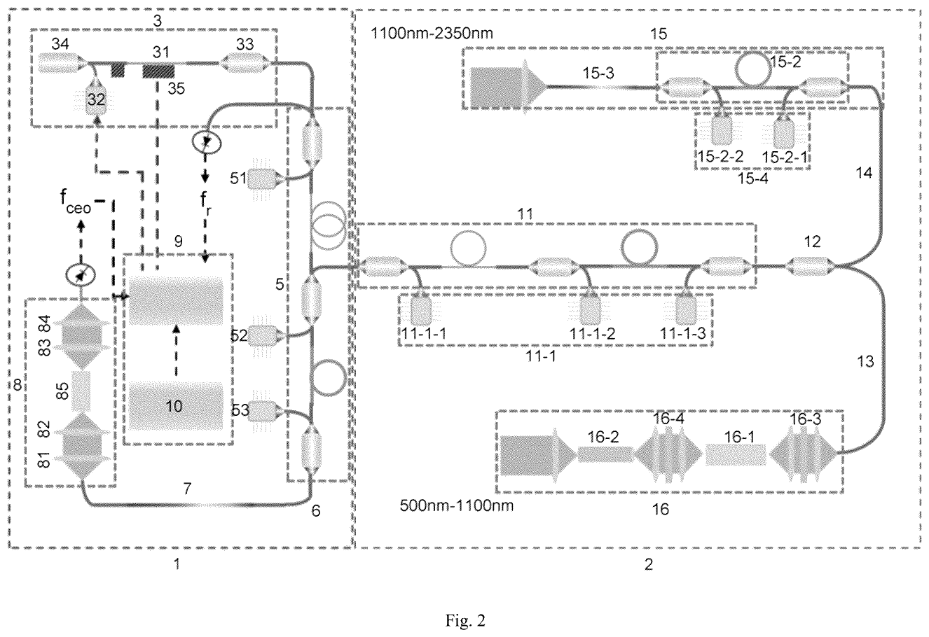

As shown in FIG. 2, an embodiment of the present disclosure provides a system for generating a visible-to-mid-infrared frequency comb. The system includes an all polarization-maintaining fiber-based frequency comb module 1 and an optical frequency comb spectral expansion module 2. The all polarization-maintaining fiber-based frequency comb module I is configured to generate a laser with evenly spaced and coherence frequencies and spectral lines. The optical frequency comb spectral expansion module 2 is configured to perform spectral expansion on the laser, covering the visible to near-infrared band and the near-infrared to mid-infrared band.

The all polarization-maintaining fiber-based frequency comb module 1 includes a laser 3, a first amplifier 5, a first all polarization-maintaining compression fiber 6, a first highly nonlinear fiber 7, a collinear self-referencing f-to-2f beat-frequency detection device 8 and a frequency locking unit 9.

The optical frequency comb spectral expansion module 2 includes a second amplifier 11, a 90:10 beam splitter 12, a second all polarization-maintaining compression fiber 13, a third all polarization-maintaining compression fiber 14, a 1100 nm-2350 nm supercontinuum unit 15 and a 500 nm-1100 nm supercontinuum unit 16. The 90:10 beam splitter has a split ratio of 90:10. The second amplifier 11 is configured to perform pulse amplification on a pulse output from the first amplifier 5 and simultaneously broaden a spectral width of the pulse through a nonlinear self-phase modulation effect. A first semiconductor laser diode unit 11-1 is configured to supply a pumping power to the second amplifier 11.

The 1100 nm-2350 nm supercontinuum unit 15 includes a third amplifier 15-2, a passive optical fiber and a second highly nonlinear fiber 15-3. The third amplifier 15-2 is connected to a second semiconductor laser diode unit 15-4 via an optical fiber. A circuit of the second semiconductor laser diode unit 15-4 is configured to control output of a 1100 nm-2350 nm laser, covering the near-infrared to the mid-infrared band.

In an embodiment, the laser 3 is an all polarization-maintaining linear-cavity mode-locked erbium-doped fiber laser based on a semiconductor saturable absorber mirror (SESAM).

In an embodiment, the first amplifier 5 is an all polarization-maintaining fiber femtosecond pulse amplifier.

In an embodiment, the third amplifier 15-2 is the all polarization-maintaining fiber femtosecond pulse amplifier.

The laser 3 has a linear cavity. The laser 3 includes a SESAM component 34, a polarization-maintaining erbium-doped fiber 31, a first semiconductor laser diode 32 and an output mirror 33. The laser 3 employs a fiber-coupled SESAM component 34 to achieve self-starting mode-locking. The SESAM component 34 is provided on a first side of the linear cavity of the laser 3, with a pigtail fiber length of approximately 15cm, a modulation depth of 15% and an absorption coefficient of 25%. A pump source is the first semiconductor laser diode 32 with a central wavelength of 976 nm. The output mirror 33 is provided on a second side of the linear cavity of the laser 3, and is configured reflect a laser emitted from the first semiconductor laser diode 32 to the polarization-maintaining erbium-doped fiber 31 to provide excitation. Specifically, a first end of the polarization-maintaining erbium-doped fiber 31 is connected to the SESAM component 34, and a second end of the polarization-maintaining erbium-doped 31 is connected to the output mirror 33. A reflection-to-transmission ratio of the output mirror 33 is 90:10. The output mirror 33 is configured to output 10% of a signal light in the linear cavity as an output of the laser. The laser is a femtosecond laser. The output laser sequentially passes through the first amplifier 5, the first all polarization-maintaining compression fiber 6, the first highly nonlinear fiber 7, the collinear self-referencing f-to-2f beat-frequency detection device 8 and the frequency locking unit 9.

In an embodiment, the laser 3 further includes a standard polarization-maintaining single-mode fiber. The polarization-maintaining erbium-doped fiber and the standard polarization-maintaining single-mode fiber are accommodated in the linear cavity. And the polarization-maintaining erbium-doped fiber and the standard polarization-maintaining single-mode fiber are both negative dispersion fibers. (Dispersion coefficients of the polarization-maintaining erbium-doped fiber and the standard polarization-maintaining single-mode fiber are both 17 ps/nm/km at 1550 nm. Considering that an optical pulse undergoes two round trips per cycle in the linear cavity, a net chromatic dispersion can be calculated to be approximately −0.02 ps/(nm·km).)

The first amplifier 5 and the second amplifier 11 each include a multi-functional device composed of three sets of wavelength division multiplexers (WDMs) and optical isolators (ISOs), along with three semiconductor laser diodes connected via optical fibers. These components are configured to broaden a pulse width, pre-amplify a power and maintain a spectral shape of a laser pulse output from the output mirror 33. Each multi-functional device is connected to a semiconductor laser diode via an optical fiber. In the first amplifier 5, three optical fibers are respectively connected to a second semiconductor laser diode 51, a third semiconductor laser diode 52 and a fourth semiconductor laser diode 53.

The first amplifier 5 is a two-stage femtosecond pulse amplification system based on an all polarization-maintaining single-mode fiber and an optical fiber component. This pulse amplification system includes a low-gain high-dispersion erbium-doped fiber pre-amplifier, a high-gain low-dispersion erbium-doped fiber main amplifier and a compressor composed of a segment of the negative dispersion fiber for chromatic dispersion compensation.

In an embodiment, the second semiconductor laser diode 51, the third semiconductor laser diode 52 and the fourth semiconductor laser diode 53 each have a central wavelength of 976 nm and a maximum power of 1600 mW.

The second amplifier 11 employs a high-gain low-dispersion erbium-doped fiber, which is configured as a high-doping-concentration polarization-maintaining erbium-doped fiber main amplifier. The second amplifier 11 is configured to perform pulse amplification on the pulse output from the first amplifier 5 and simultaneously broaden the spectral width of the pulse using the nonlinear self-phase modulation effect. In the second amplifier 11, three optical fibers are respectively connected to a fifth semiconductor laser diode 11-1-1, a sixth semiconductor laser diode 11-1-2 and a seventh semiconductor laser diode 11-1-3.

An operating principle of the all polarization-maintaining fiber-based frequency comb module 1 is as follows.
1. A pump current of the first semiconductor laser diode 32 is increased. When a pump power reaches 39.6 mW, an output spectrum has a 3 dB bandwidth of 13.3 nm, and an average output power of the pulse reaches 12.66 mW.
2. Drive currents of the second semiconductor laser diode 51 and the third semiconductor laser diode 52 are increased. When the pump power reaches 1542 mW, a spectrum width of the pulse output from the first amplifier 5 is 25.15 nm, and a corresponding average output power reaches 332 mW.

An output end of the first amplifier 5 is connected to the first all polarization-maintaining compression fiber 6 (which functions as a single optical fiber) to generate a broadband supercontinuum spectrum spanning an octave and to improve a peak power of the pulse. The first all polarization-maintaining compression fiber 6 includes a segment of negative dispersion fiber, which has a dispersion coefficient of 18 ps/nm/km at 1550 nm and a mode field diameter of 10.5 μm. In an embodiment, when the power of the pulse output from the first amplifier 5 reaches its maximum, the width of the pulse is compressed to below one hundred femtoseconds by optimizing the length of the first all polarization-maintaining compression fiber 6.

A laser enters the first highly nonlinear fiber 7 through the first all polarization-maintaining compression fiber 6. The power of the pulse pump laser incident into the first high-nonlinearity fiber 7 (having a length of 57 cm) is adjusted to control a shape and a spectral power density distribution of the generated supercontinuum spectrum. The supercontinuum spectrum generated by the first highly nonlinear fiber 7 is further coupled into the collinear self-referencing f-to-2f beat-frequency detection device 8 for detecting a carrier-envelope offset (f_{ceo}) signal.

In the collinear self-referencing f-to-2f beat-frequency detection device 8, a laser sequentially passes through a first lens 81, a second lens 82, a first periodically poled lithium niobate (PPLN) crystal 85, a third lens 83 and a fourth lens 84. Two self-focusing lenses with pigtails (the first lens 81 and second lens 82) are configured to collimate and focus the supercontinuum spectrum into the first PPLN crystal 85. 1015 nm optical pulses generated by frequency multiplication in the first PPLN crystal 85 are then coupled sequentially through the third lens 83 and the fourth lens 84, where they interfere and generate a beat frequency. The resulting radio-frequency signal from the beat frequency is the f_{ceo} signal. The detected optical frequency signal f_{ceo} is locked to a hydrogen atomic clock in the frequency locking unit 9 through a servo feedback circuit in the frequency locking unit 9, achieving a locking precision that is improved by an order of magnitude compared to the current rubidium atomic clock.

Once the repetition frequency and the offset frequency locking processes are completed in the all polarization-maintaining fiber-based frequency comb module 1, the laser output from the laser 3 is a series of lasers with evenly spaced and coherence frequencies and spectral lines, i.e., a femtosecond optical frequency comb. (A process of the repetition frequency locking is performed as follows. The laser 3 includes a piezoelectric ceramic actuator 35, and the piezoelectric ceramic actuator 35 is configured to stretch an optical fiber in the laser 3 to lock the repetition frequency to an atomic clock 10 in the frequency locking unit 9. The optical fiber stretched by the piezoelectric ceramic actuator 35 is the polarization-maintaining erbium-doped fiber 31. A process of the offset frequency locking is performed as follows. The collinear self-referencing f-to-2f beat-frequency detection device 8 is configured to lock the radio-frequency signal, i. e., the f_{ceo} signal (offset frequency) onto the atomic clock 10 in the frequency locking unit 9 through the beat-frequency method.) In order to achieve the spectral expansion output of the femtosecond optical frequency comb, the pulse output from the first amplifier 5 in the all polarization-maintaining fiber-based frequency comb module 1 is further amplified by the second amplifier 11. Then, the 90:10 beam splitter 12 is configured to split the pulse into a first laser beam and a second laser beam. The first laser beam passing through a 10% splitting port of the 90:10 beam splitter is configured to generate a mid-infrared spectrum, while the second laser beam passing through a 90% splitting port of the 90:10 beam splitter is configured to generate a visible spectrum.

An operating principle of the optical frequency comb spectral expansion module 2 is as follows.

Firstly, the all polarization-maintaining fiber-based frequency comb module 1 is configured to output the femtosecond laser to pass through the second amplifier 11 (including the low-gain high-dispersion erbium-doped fiber pre-amplifier and the high-gain low-dispersion erbium-doped fiber main amplifier). The fifth semiconductor laser diode 11-1-1 (used for pre-amplification), the sixth semiconductor laser diode 11-1-2 (used for the mixed main amplification stage) and the seventh semiconductor laser diode 11-1-3 are connected to the second amplifier 11. (The fifth semiconductor laser diode 11-1-1, the sixth semiconductor laser diode 11-1-2 and the seventh semiconductor laser diode 11-1-3 form the first semiconductor laser diode unit 11-1.)

### Operation of the Second Amplifier 11

When a pump current of the fifth semiconductor laser diode 11-1-1 is increased to make the pump power reach 460 mW, an average output power of the pulse reaches 46 mW. Then, the drive currents of the sixth semiconductor laser diode 11-1-2 and the seventh semiconductor laser diode 11-1-3 are increased. When the pump power reaches 2000 mW, the average output power of the second amplifier 11 reaches 600 mW. When the power of the pulse output from the second amplifier 11 reaches its maximum, the width of the pulse is compressed to below one hundred femtoseconds by optimizing the lengths of the second all polarization-maintaining compression fiber 13 and the third all polarization-maintaining compression fiber 14.

### Operation Principle of the 1100 nm-2350 nm (Near-Infrared to Mid-Infrared Band) Supercontinuum Unit 15

The first laser beam passing through the 10% splitting port of the 90:10 beam splitter 12 is used to generate the mid-infrared spectrum. Due to the low power after splitting, the third amplifier 15-2 (connected to an eighth semiconductor laser diode 15-2-1 and a ninth semiconductor laser diode 15-2-2) is configured to amplify the 1560 nm laser passing through the third all polarization-maintaining compression fiber 14. This amplification increases the laser power to 200 mW, reaching the peak power required for nonlinear conversion. Then, the 1560 nm laser passes through a segment of passive optical fiber to compress the pulse. The compressed 1560 nm laser further passes through a segment of the second highly nonlinear fiber 15-3 for spectral expansion, achieving laser output in the 1100 nm-2350 nm near-infrared to mid-infrared band.

In this embodiment, a length of the second highly nonlinear fiber 15-3 is determined to be 40 cm. The current powers of the eighth semiconductor laser diode 15-2-1 and the ninth semiconductor laser diode 15-2-2 are adjusted to control the pump laser power of the pulse incident on the all polarization-maintaining second highly nonlinear fiber 15-3, thereby regulating the shape and spectral power density distribution of the generated supercontinuum spectrum. The circuits of the eighth semiconductor laser diode 15-2-1 and the ninth semiconductor laser diode 15-2-2 are configured to control output of a 1100 nm-2350 nm laser, covering the near-infrared to mid-infrared band, enabling more targeted and efficient measurement of a to-be-tested laser.

### Operation Principle of the 500 nm-1100 nm (Visible Light To Near-Infrared Band) Supercontinuum Unit 16

The second laser beam passing through the 90% splitting port of the 90:10 beam splitter 12 is used to generate the visible spectrum. A width of the pulse is first compressed by a segment of passive optical fiber to achieve the peak power required for nonlinear conversion. After compression by the second all polarization-maintaining compression fiber 13, the 1560 nm fundamental optical pulse enters a PPLN crystal (i.e., the second PPLN crystal 16-1) for frequency multiplication, thereby generating a 780 nm frequency-multiplied light with an average power of 160 mW and a conversion efficiency of 28.6%. Subsequently, the 780 nm frequency-multiplied light is injected into a segment of photonic crystal fiber 16-2 for spectral expansion, realizing an output of the optical frequency comb spanning 500 nm-1100 nm, which covers the visible to near-infrared band.

Specifically, a first collimation assembly and a first half-wave plate 16-3 is provided in front of the second PPLN crystal 16-1. A second collimation assembly and a second half-wave plate 16-4 is provided in front of the photonic crystal fiber 16-2. The first collimation assembly and the first half-wave plate 16-3 are configured to adjust a pulse pump laser power incident on the second PPLN crystal 16-1 to control a shape and a power density distribution of a supercontinuum spectrum. The second collimation assembly and the second half-wave plate 16-4 are configured to adjust a pulse pump laser power incident on the photonic crystal fiber 16-2 to control the shape and the power density distribution of the supercontinuum spectrum.

Described above are merely preferred embodiments of the present disclosure, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A system for generating a visible-to-mid-infrared frequency comb, comprising:
an all polarization-maintaining fiber-based frequency comb module; and
an optical frequency comb spectral expansion module;
wherein the all polarization-maintaining fiber-based frequency comb module is configured to generate a laser with evenly spaced and coherence frequencies and spectral lines;
the optical frequency comb spectral expansion module is configured to perform spectral expansion on the laser to output the visible-to-mid-infrared frequency comb;
the optical frequency comb spectral expansion module comprises a first amplifier, a beam splitter, a 1100 nm-2350 nm supercontinuum unit and a 500 nm-1100 nm supercontinuum unit;
the first amplifier is configured to perform pulse amplification on the laser to obtain an amplified laser; the beam splitter is configured to split the amplified laser into a first laser beam and a second laser beam to respectively enter the 1100 nm-2350 nm supercontinuum unit and the 500 nm-1100 nm supercontinuum unit;
the 1100 nm-2350 nm supercontinuum unit comprises a second amplifier, a passive optical fiber and a first highly nonlinear fiber; and the first laser beam is configured to pass sequentially through the second amplifier, the passive optical fiber and the first highly nonlinear fiber; and
the second amplifier is connected to a first semiconductor laser diode unit; and a circuit of the first semiconductor laser diode unit is configured to be connected to output a 1100 nm-2350 nm laser.

2. The system of claim 1, wherein the beam splitter is a 90:10 beam splitter; the 90:10 beam splitter has a split ratio of 90:10;
the optical frequency comb spectral expansion module further comprises a first all polarization-maintaining compression fiber and a second all polarization-maintaining compression fiber;
the first laser beam is configured to be output from a 10% splitting port of the 90:10 beam splitter to pass through the second all polarization-maintaining compression fiber to enter the 1100 nm-2350 nm supercontinuum unit; and
the second laser beam is configured to be output from a 90% splitting port of the 90:10 beam splitter to pass through the first all polarization-maintaining compression fiber to enter the 500 nm-1100 nm supercontinuum unit.

3. The system of claim 2, wherein the all polarization-maintaining fiber-based frequency comb module comprises a laser, a third amplifier, a third all polarization-maintaining compression fiber, a second highly nonlinear fiber, a collinear self-referencing f-to-2f beat-frequency detection device and a frequency locking unit;
the laser is configured to output a laser to pass sequentially through the third amplifier, the third all polarization-maintaining compression fiber, the second highly nonlinear fiber, the collinear self-referencing f-to-2f beat-frequency detection device and the frequency locking unit;
the laser comprises a piezoelectric ceramic actuator, and the piezoelectric ceramic actuator is configured to stretch an optical fiber in the laser to lock a repetition frequency onto an atomic clock of the frequency locking unit;
the collinear self-referencing f-to-2f beat-frequency detection device is configured to lock a detected radio-frequency signal to the atomic clock of the frequency locking unit;
wherein the detected radio-frequency signal is a carrier-envelope offset (f_{ceo}) signal; and
the atomic clock is a hydrogen atomic clock.

4. The system of claim 3, wherein the laser further comprises a semiconductor saturable absorber mirror (SESAM) component, a polarization-maintaining erbium-doped fiber, a semiconductor laser diode and an output mirror;
the optical fiber stretched by the piezoelectric ceramic actuator is the polarization-maintaining erbium-doped fiber;
the SESAM component is provided on a first side of a linear cavity of the laser;
the semiconductor laser diode is a pump source;
the output mirror is provided on a second side of the linear cavity of the laser, and is configured to reflect a laser emitted from the semiconductor laser diode to the polarization-maintaining erbium-doped fiber to provide excitation;
a first end of the polarization-maintaining erbium-doped fiber is connected to the SESAM component, and a second end of the polarization-maintaining erbium-doped fiber is connected to the output mirror;
a reflection-to-transmission ratio of the output mirror is 90:10;
the output mirror is configured to output 10% of a signal light in the linear cavity as an output of the laser; and
the laser is a femtosecond laser.

5. The system of claim 4, wherein the laser further comprises a standard polarization-maintaining single-mode fiber; the polarization-maintaining erbium-doped fiber and the standard polarization-maintaining single-mode fiber are accommodated in the linear cavity; and the polarization-maintaining erbium-doped fiber and the standard polarization-maintaining single-mode fiber are both negative dispersion fibers;
the first amplifier comprises a second semiconductor laser diode unit;
the second semiconductor laser diode unit is configured to supply a pumping power to the first amplifier; and
the first amplifier is configured to output an average power of 600 mW in response to a case that the pumping power of the second semiconductor laser diode unit is increased to 2000 mW.

6. The system of claim 1, wherein the 500 nm-1100 nm supercontinuum unit comprises a first collimation assembly and a first half-wave plate, a periodically poled lithium niobate (PPLN) crystal, a second collimation assembly, a second half-wave plate and a photonic crystal fiber;
the first collimation assembly, the first half-wave plate, the PPLN crystal, the second collimation system, the second half-wave plate and the photonic crystal fiber are sequentially arranged along an optical path; and the PPLN crystal is configured to perform frequency multiplication on the laser;
the first collimation assembly and the first half-wave plate are configured to adjust a pulse pump laser power incident on the PPLN crystal to control a shape and a power density distribution of a supercontinuum spectrum; and
the second collimation assembly and the second half-wave plate are configured to adjust a pulse pump laser power incident on the photonic crystal fiber to control the shape and the power density distribution of the supercontinuum spectrum.
